(19) United States
(12) Patent Application Publication
(10) Pub. No.: US 2010/0108217 A1
(43) Pub. Date: May 6, 2010

(54) Dual-chambered inner tube and valve system

(75) Inventor: Brian Scott Bradke, Troy, NY (US)

Correspondence Address: Brian Scott Bradke, 12 Michigan Ave, Troy, NY, 12180, US

(73) Assignee: Brian Scott Bradke, Troy, NY (US)

(21) Appl. No.: 12/263,463

(22) Filed: Nov. 1, 2008

(51) Int. Cl. B60C 29/00

(52) U.S. Cl. 152/427

(57) ABSTRACT

A dual-chambered inner tube and valve system comprising a primary tube and a secondary tube joined by a common valve assembly is installed into the wheel cavity. The primary and secondary tubes are positioned side-by-side throughout the circumference of the cavity with the valve assembly positioned in the rim's aperture. The chambers inflate independently and can be selected by a tube selector valve within the main valve assembly. Since there is one valve assembly of standard dimension for both tubes, rim modification is unnecessary. With the primary tube inflated, the secondary tube is devoid of air and stowed between the primary tube and the wheel, which may be used as normal. In the event of a flat tire, the selector valve is moved to a secondary position and the secondary tube is inflated, effectively repairing the wheel without removing the tire from the wheel or wheel from the bicycle.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention pertains to inner tubes for common tire systems more specifically, to an improved inner tube and valve system for bicycle tires allowing a user to inflate a secondary tube without removing the tire from the rim or the rim from the bicycle.

### BACKGROUND OF THE INVENTION

### Prior Art

As it is commonly known, a bicycle wheel is comprised of 3 elements: a rim, an inner tube (generally, tubes) and a tire. The rim gives rigid support to the bicycle using a hub-and-spoke system and is responsible for the locomotion of the bicycle and its user. The tube provides cushioning between the rim and the ground and absorbs shock by virtue of an annular bladder filled with air at some pressure. To meet this function, inner tubes are generally made from rubber because it is a strong, incompressible material capable of considerable deformation and elastic recovery. These structural properties also provide consistent performance and high reliability of the tube. Also, common inner tubes are manufactured in varying sizes so as to be compatible with different sizes and types of bicycle wheels. The tire protects the tube from puncture and thus helps to maintain the integrity of the wheel. While no one component is more important than the others, the inner tube is frequently the sole cause of bicycle wheel malfunctions.

One of the most common malfunctions in cycling is the occurrence of flat tires. A flat tire is the result of a structurally compromised inner tube causing the tube to lose air pressure. The rim subsequently rides down onto the tire making the wheel unstable. Locomotion and directional control become substantially more difficult and the ride is not as smooth as with a fully pressurized inner tube. The rider must stop riding to avoid damaging the rim and must repair the tube before continuing to efficiently use the bicycle.

Flat tires have many causes, the two most common of which are “pinch-flats” and punctures. A pinch-flat is the result of the tube being pinched between the rim and the tire, usually as the wheel impacts an external object (i.e. a pothole or a tree root). Punctures are more common and occur when a sharp object such as a nail punctures both the tire and the tube. Both generally occur while the user is riding the bicycle and result in the complete loss of air pressure from the tube.

After a flat tire has occurred the rider has limited options for repairing the wheel. In all cases, the wheel must be removed from the bicycle and the tire removed from the rim. After exposing the tube, the rider can either repair the hole using a patch or completely replace the damaged inner tube. Patching the tube requires considerable time to locate the hole and allow the patching adhesive to set. In both circumstances the rider must carry special equipment and tools which add unnecessary weight and bulk. Furthermore, should the user be involved in a race, they would be required to stop cycling, remove the wheel and repair the tube before continuing, resulting in lost time.

The problems associated with flat tires have long been recognized and many solutions have been focused on preventing them from occurring. U.S. Pat. Nos. 6,877,537 (2005) and 5,785,779 (1998) were for tire liners that attempted to isolate the inner tube and decrease the likelihood of puncture. Unfortunately, sharp objects could still puncture that lining and deflate the tube. Even with these systems, pinch flats are still likely to occur as the inner tube is not protected from being pinched inside the tire. U.S. Pat. No. 5,679,184 (1997) proposed a tire design to eliminate pinch flats, but left the tire susceptible to punctures. While these solutions might decrease the incidence of flat tires, they do not completely prevent them and each still requires a traditional inner tube repair.

Solutions to repairing flat tires without replacing or patching the tube have been proposed and usually relate to a “tube within a tube” system. For example, U.S. Pat. Nos. 5,385,191 (1995), 6,820,667 (2004), 5,538,061 (1996), and 2,169,041 (1936) are all some variant of a “tube within a tube”. This concept consists of a primary tube and a secondary tube positioned concentrically in the tire. The primary tube is inflated and functions as a typical inner tube. The secondary tube is positioned within the primary tube and may or may not be attached to the primary tube. Should the primary tube become compromised and run flat, the user can inflate the secondary tube. The secondary tube expands into the space previously occupied by the primary tube and restores the wheel's integrity. The problem with these systems is that in the event of a puncture, the sharp object that punctured the tire and primary tube can also puncture the secondary tube. The secondary tube is also susceptible to pinch flats by getting caught between the tire and the rim along with the primary tube. In these cases, inflation of the secondary tube would fail and the user would have to revert to a traditional repair method.

Similar solutions attempt to alleviate the above problems by positioning multiple inner tubes one atop another within the tire. U.S. Pat. Nos. 5,746,850 (1998) and 4,293,017 (1981) are examples of this arrangement. This configuration does provide more reliability in terms of separate inner tube systems but introduces new problems of complexity in manufacturing, installation and operation. Further disadvantages are present in the valve arrangements of the previous inventions. Most valve arrangements are often complex to operate and involve different size valve stems. Some systems further have separate valves for each tube, requiring a second aperture in the rim. This is undesirable because bicycle rims are usually quite expensive and the user is unwilling or unable to modify them.

State of the art solutions to the issue have not yet addressed the potential for a dual-chambered inner tube and valve system that can address the problems outlined above. It is in this light that the present invention was developed.

### OBJECTS AND ADVANTAGES

Several objects and advantages of my invention are:
(a) to provide a dual-chambered inner tube and valve system that is compatible with conventional bicycle wheel systems.
(b) to provide a means of repairing a flat tire without removing the wheel from the bicycle, or the tire from the wheel.
(c) to provide a means of independently inflating separate chambers within the wheel without the use of multiple valves and/or modifications to the rim.
(d) to provide a dual-chambered inner tube and valve system that is simple in construction, installation and use.
(e) to provide a dual-chambered inner tube and valve system that addresses the state of the art issues addressed in the previous section, namely minimizing the likelihood of both pinch- and puncture-caused flat tires.

### SUMMARY OF THE INVENTION

The present invention overcomes the inadequacy of the prior art in the field of fixing flat tires. More specifically, a dual-chambered inner tube and valve system is disclosed for use within a standard bicycle wheel. When installed, the invention allows the user to inflate a secondary inner-tube without modifying the components of the wheel and without removing the tire.

The invention consists of two air-tight annular chambers positioned side-by-side and joined together by a common valve stem. The valve stem has two sections, an upper and a lower section. The upper section consists of a standard pneumatic valve (Schrader or Presta style valves, for example) which allows the user to supply air at a given pressure and closes automatically to contain that pressure within the selected chamber. The lower section consists of a selector valve which allows the user to select which compartment is inflated. The valve stem is of standard dimensions so that the aperture of the rim need not be adapted. The dual-chambered inner tube will fit entirely within the annular space formed between the tire and rim and will therefore be completely compatible with a standard bicycle wheel.

Upon installation, both chambers will freely occupy the annular cavity formed between the tire and rim. As the primary tube is inflated, the second tube remains devoid of air and collapses neatly beside the primary tube, within the wheel. Should the primary tube become compromised and air pressure lost, the user may then turn the selector valve in the lower valve stem to a secondary position. This, in effect, closes off the primary tube and opens the secondary tube to the valve stem. The user may then attach an inflation device and begin supplying air to the invention. The second chamber will begin to inflate, expanding into the wheel space and pushing the now deflated primary tube aside. The secondary tube then provides the function of cushion and support in place of the primary tube. The user may now continue riding the bicycle on the fully inflated secondary tube, having never removed the wheel from the bicycle or the tire from the wheel.

Other features and advantages of the present invention will become apparent from the following more detailed description, taken in conjunction with the accompanying drawings, which illustrate the principles of the invention.

### BRIEF DESCRIPTION OF THE DRAWINGS

FIG. 1 is a perspective view of a wheel assembly incorporating the dual-chambered inner tube and valve system of the present invention.

FIG. 2 is a perspective view of the dual-chambered inner tube and valve system before installation into the wheel assembly.

FIG. 3 is an enlarged view of the valve system of the present invention with the anchoring nut removed.

FIG. 4 is a perspective view of a section taken along line 4-4 of FIG. 3 with the anchoring nut removed.

FIG. 5 is an enlarged cross section taken along line 4-4 of FIG. 3 with the anchoring nut removed.

FIG. 6 is an exploded perspective of the valve system of the present invention.

FIG. 7 is an enlarged cross section taken along line 7-7 of FIG. 1 showing an inflated primary tube and a stowed secondary tube.

FIG. 8 is an enlarged cross section taken along line 7-7 of FIG. 1 showing a compromised primary tube and a stowed secondary tube.

FIG. 9 is an enlarged cross section taken along line 7-7 of FIG. 1 showing a compromised primary tube and a partially inflated secondary tube.

FIG. 10 is an enlarged cross section taken along line 7-7 of FIG. 1 showing a fully inflated secondary tube and a stowed primary tube.

### DETAILED DESCRIPTION OF A PREFERRED EMBODIMENT

In order for those skilled in the art to further understand the present invention, a description is provided in the following details. However, these descriptions and included drawings are intended only to aid in understanding the objects, features and characteristics of the present invention; not to confine the scope or spirit as defined in the claims of the present invention.

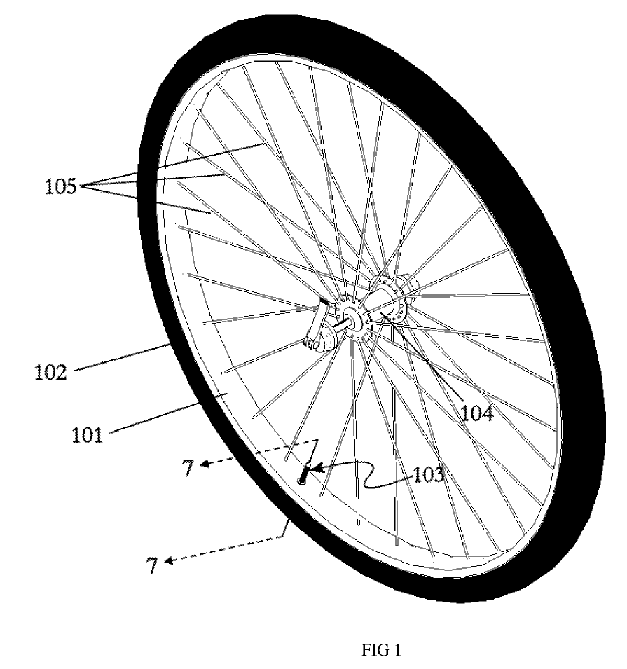

FIG. 1 shows a conventional bicycle wheel incorporating the dual-chambered inner tube and valve system of the present invention. The wheel comprises a rim 101 rigidly connected to a hub 104 by way of spokes 105. A tire 102 is shown mounted to the rim 101 and protects the dual-chambered inner tube (not pictured) from external objects which may compromise the tube's structural integrity. The valve system of the present invention 103 is shown protruding through the rim's aperture. As depicted, both chambers of the present invention can be accessed through the same standard-sized valve system. Because of this feature, modifications to the rim are not necessary.

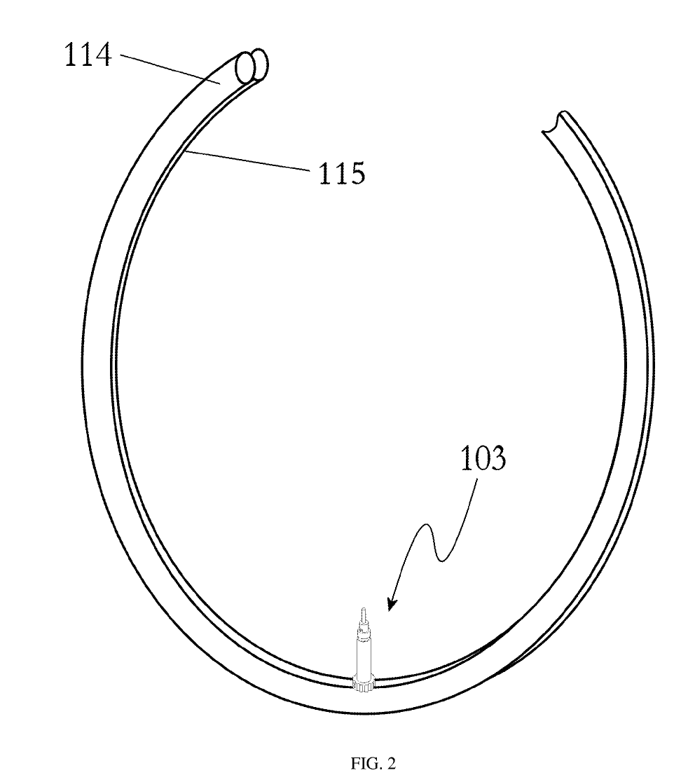

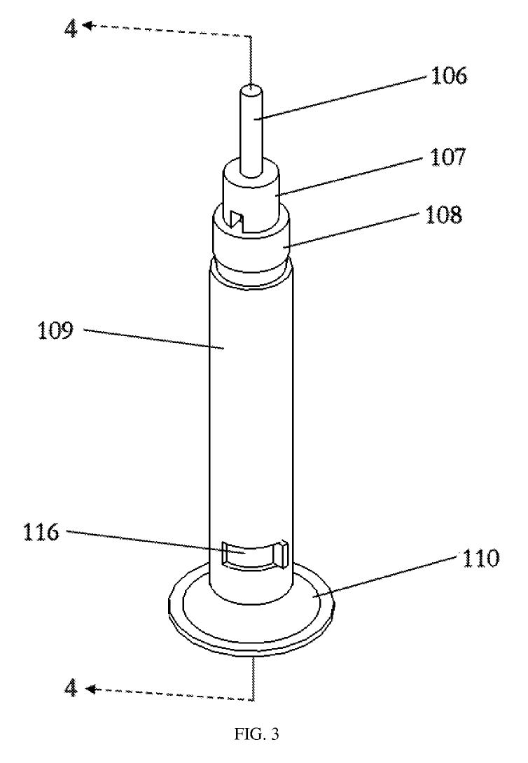

FIG. 2 is a detailed perspective drawing of the dual-chambered inner tube and valve system uninstalled with a section cut-away for clarity. The primary tube 114 is shown positioned beside the secondary tube 115. These tubes are independent of each other and both capable of providing support for the wheel system when installed. They are joined by the valve system 103 which is described in greater detail in FIGS. 3-6.

A perspective view of the valve system of the present invention is shown in FIG. 3. A valve flange 110 is connected to the primary and secondary tubes (not pictured) by vulcanization or some other suitable means. A main valve body 109 being cylindrical in form extends up from the valve flange and has two sections, an upper and lower section. The lower section contains a tube selector 116 which can be seen through a notch cut in the main valve body 109. The tube selector 116 allows the user to selectively inflate the primary and secondary tubes by virtue of a rotating valve. The upper section of the main valve body 109 contains a conventional pneumatic valve which allows the user to apply an inflation device and supply air at some pressure. When the inflation device is removed the pneumatic valve hermetically seals the inner tube and retains the desired pressure. The two most common types of pneumatic valves found on bicycle tubes are Schrader and Presta type valves. Schrader valves are typically found on recreational tubes while Presta valves are more common on high-performance racing tubes. For the purpose of example, a Presta style valve is depicted but will not be described in detail. The Presta style pneumatic valve consists of a valve core 108, a valve pin 106 and a valve nut 107 and these components will be collectively referred to as a “Presta valve”.

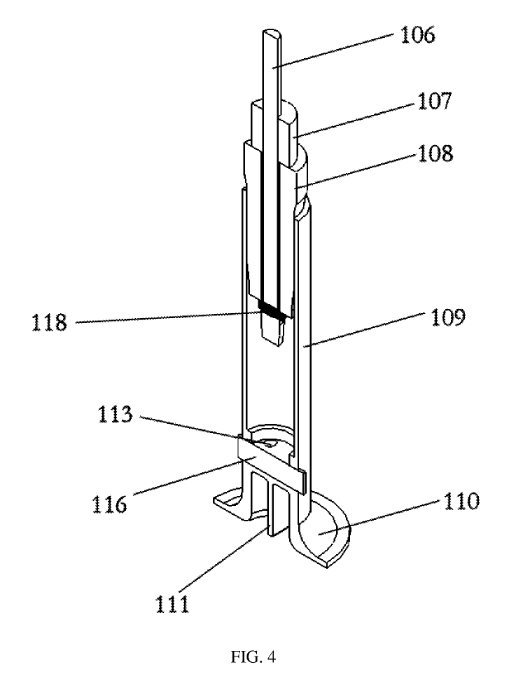

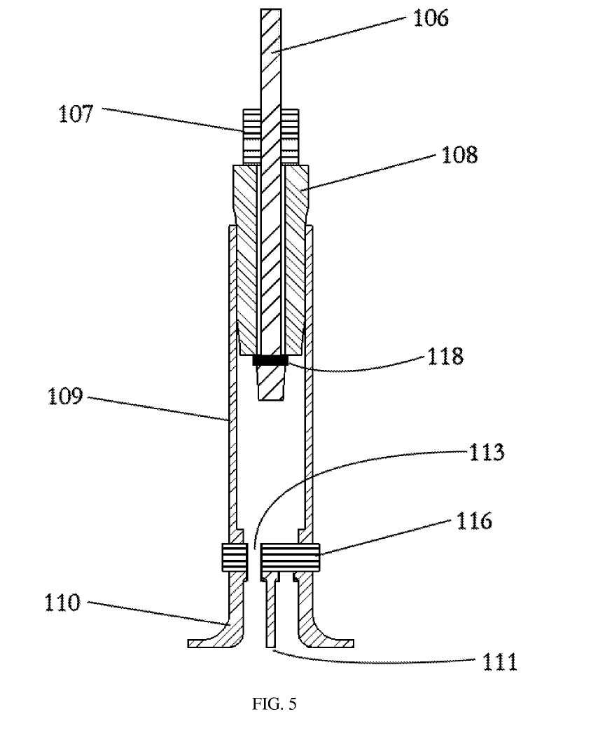

A perspective view of a section taken along line 4-4 of FIG. 3 reveals the inner assembly of the valve system and is shown in FIG. 4. A two-dimensional view of the same cross section is shown in FIG. 5. The Presta style pneumatic valve is shown in greater detail in the upper section of the main valve body 109. The valve pin 106 runs completely through the long axis of the valve core and is threaded at the top to accept the valve nut 107. At the lower end of the valve pin 106 is a valve stopper 118 which is has a larger diameter than the bore of the valve core 108. As depicted, the lower section of the main valve body 109 contains the tube selector 116 having a tube selector aperture 113 which allows pressurized air to pass to the selected compartment. The primary and secondary tubes are kept independent by the valve septum 111 below the tube selector 116. The valve septum 111 is sealed against the tube selector 116 by a lower gasket (not depicted) which prevents air from leaking between tubes.

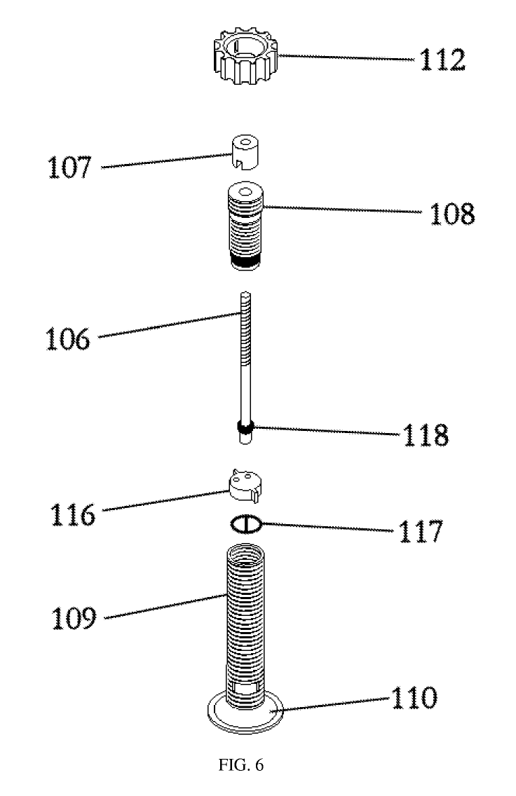

FIG. 6 is an exploded view showing the main components of the valve system assembly. The main valve body 109 and valve flange 110 are shown as one component. The lower gasket 117 is inserted into the main valve body 109 and fixed to the valve septum (not depicted). The tube selector 116 is positioned above and held tightly to the lower gasket 117 and rotates within the main valve body 109. The components of the Presta valve (106, 107 & 108) are assembled and fixed to the main valve body 109. A selector nut 112 is fitted over the entire assembly and connects to the selector valve 116 after the valve system has been installed through the rim aperture. The selector nut 112 holds the valve system in place when installed. It also provides the user a means to easily select either the primary or secondary tube for inflation as it is connected to the tube selector 116.

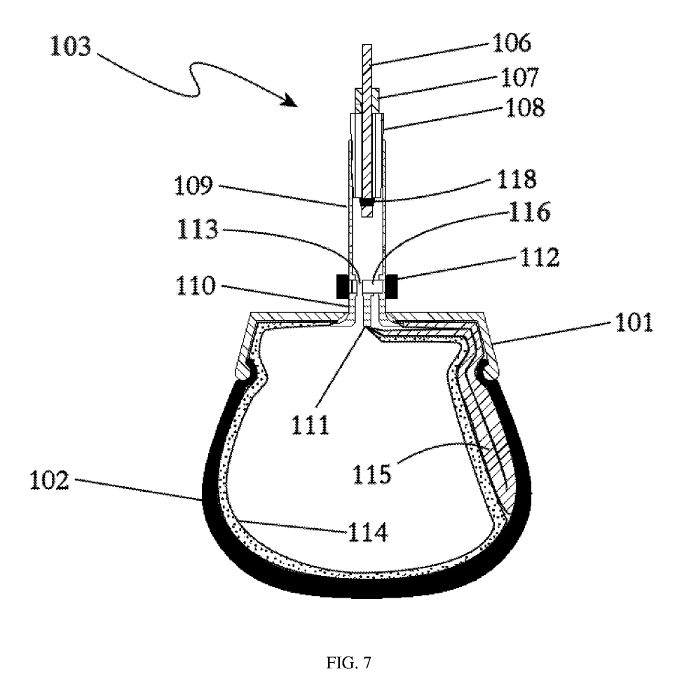

FIGS. 7-10 show a detailed cross section of the installed dual-chambered inner tube and valve system taken along line 7-7 of FIG. 1 and shows the operation of the invention. The rim 101 and the tire 102 form an annular wheel cavity for the installation of a conventional inner tube or, in this case, the present invention. The valve system 103 is shown protruding through the rim's aperture and secured in place by virtue of the valve's lower flange 110 and the selector nut 112 which is slipped over the top of the valve system after installation. The selector nut 112 also serves as a means to turn the tube selector 116 and select which compartment is to be inflated. For initial use, the user selects the primary tube 114 for inflation using the selector nut 112. This aligns the tube selector aperture with the primary tube's side of the valve septum 111. An inflation device is applied to the Presta valve and air is supplied under pressure to the invention. This causes the primary tube 114 to inflate, expanding into and filling the annular wheel cavity. The secondary tube 115 remains devoid of air and is neatly stowed until needed. When the desired pressure in the primary tube is attained, the inflation device is removed and the Presta valve hermetically seals the primary tube. At this point the wheel is ready for normal use.

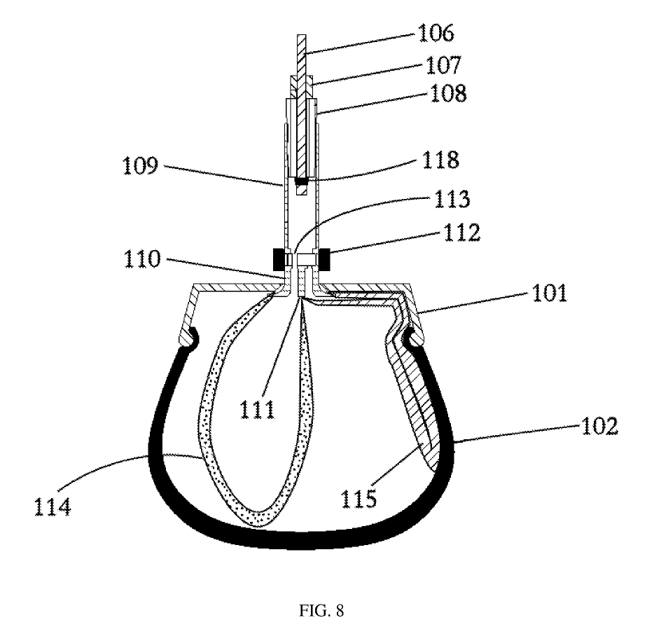

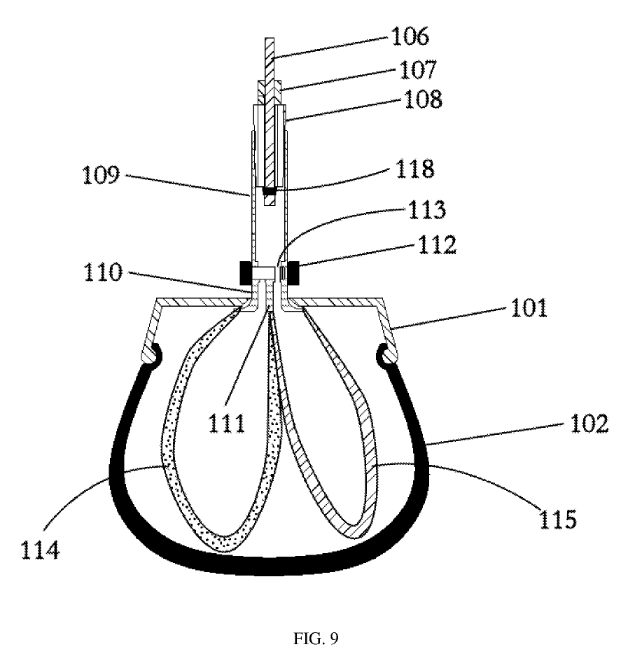

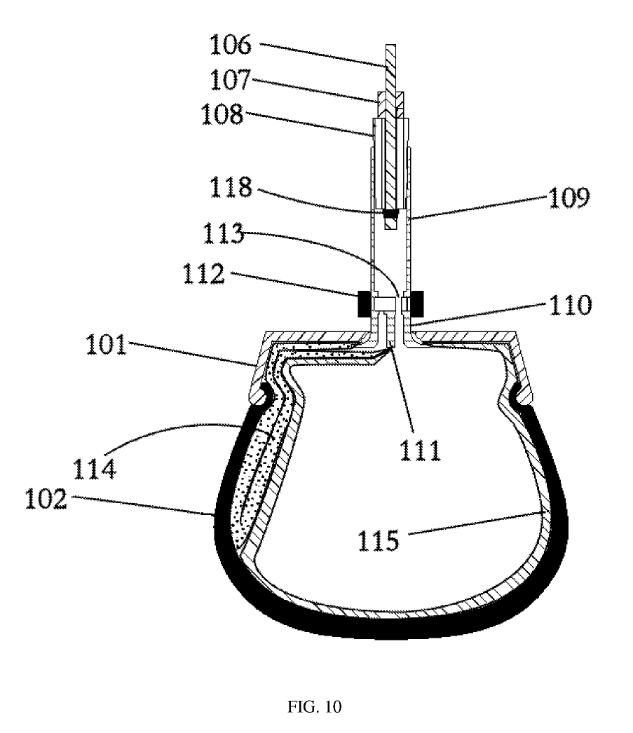

FIG. 8 shows a compromised primary tube 114 resulting in a flat tire. The primary tube 114 no longer provides support to the wheel system and must be replaced. The user rotates the selector nut 112 to the secondary position which aligns the tube selector aperture 113 with the secondary tube 115 side of the valve septum 111 as seen in FIG. 9. Again, an inflation device is applied to the Presta valve and air is supplied under pressure. The positive pressure causes the secondary tube 115 to expand into the annular wheel cavity, pushing aside the damaged primary tube 114. FIG. 10 shows a fully inflated secondary tube 115 occupying the annular wheel cavity and providing support to the wheel. The damaged primary tube 114 has been pushed aside and the wheel is again ready for normal use, having never removed the tire 102 from the rim 101, or the wheel from the bicycle.

I claim:

1. An inner tube for use in a wheel assembly, said wheel assembly including a generally circular rim having a pair of spaced flanges forming an outwardly open annular well therearound and an aperture through the rim, a tire mounted on said rim so as to define an annular wheel cavity in conjunction with said rim, said inner tube being positionable in said cavity between said rim and said tire, said inner tube comprising:
(a) an inflatable portion having an inflatable primary tube and an inflatable secondary tube, and
(b) a valve assembly attached to said inflatable portion for insertion through said aperture in said rim for selectively inflating said primary or secondary tubes.

2. The inner tube of claim 1 wherein:
(a) said primary and secondary tubes are of similar construction and dimension but structurally and volumetrically independent,
(b) said primary and secondary tubes are positioned side-by-side throughout the circumference of said cavity when said inner tube is disposed in said cavity,
whereby said secondary tube remains devoid of air and stowed adjacent to said primary tube within said cavity, said secondary tube remaining impervious to elements which may compromise its structural integrity.

3. The inner tube of claim 1 wherein said valve assembly comprises:
(a) a generally cylindrical main valve body,
(b) a flange for mating said primary and secondary tubes to said valve assembly,
(c) a standard pneumatic valve which hermetically seals said primary and secondary tubes after they have been inflated, and
(d) a tube selector which is contained within said main valve body and allows a user to selectively inflate said primary tube or said secondary tube.

4. The inner tube of claim 3 wherein said tube selector comprises:
(a) a rotating valve concentrically located within said main valve body which has two positions; a position for inflating said primary tube and another position for inflating said secondary tube,
(b) a valve septum for isolating said primary tube from said secondary tube below said rotating valve, and
(c) a gasket for hermetically sealing said valve septum to said rotating valve and said primary tube from said secondary tube.

5. The inner tube of claim 4 wherein said rotating valve has a pair of diametrically opposed protrusions which extend radially outward through said main valve body, whereby said rotating valve may be engaged by a selector nut.

6. The inner tube of claim 5 wherein said selector nut being rigidly connected to said rotating valve after installation of said inner tube in said cavity, whereby said rotating valve can be easily moved between said positions.
